(19) United States
(12) Patent Application Publication
(10) Pub. No.: US 2009/0124337 A1
(43) Pub. Date: May 14, 2009

(54) METHOD OF CONTROLLING A GAMING SYSTEM, A PLAYER INTERFACE FOR A GAMING SYSTEM AND A METHOD OF GAMING

(75) Inventors: Martin Stephen Lyons, Lane Cove (AU); Robert Linley Muir, Lane Cove (AU)

Correspondence Address: MCANDREWS HELD & MALLOY, LTD, 500 WEST MADISON STREET, SUITE 3400, CHICAGO, IL, 60661, US

(73) Assignee: ARISTOCRAT TECHNOLOGIES AUSTRALIA PTY LIMITED, Lane Cove (AU)

(21) Appl. No.: 12/134,130

(22) Filed: Jun. 5, 2008

(30) Foreign Application Priority Data
Jun. 7, 2007 (AU) 2007903068

(51) Int. Cl. A63F 13/00; A63F 9/24

(52) U.S. Cl. 463/20; 463/36

(57) ABSTRACT

A gaming system includes a player interface having a touch screen display. The display includes a bet manipulation area, a bet commitment area and a chip stack area. A player may manipulate tokens by touching a displayed token on the screen and dragging their finger across the screen to carry the token to a new position. Different display areas correspond to different functions.

### RELATED APPLICATIONS

This application claims priority to Australian Provisional Patent Application No. 2007903068, having an international filing date of Jun. 7, 2007, entitled “Method Of Controlling A Gaming System, A Player Interface For A Gaming System And A Method Of Gaming,” which is hereby incorporated by reference herein in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention relates to a gaming system, a player interface for a gaming system and a method of gaming. Traditionally, electronic gaming machines have taken the form of slot machines where a player plays a game involving reels that spin and prizes are awarded based on the position at which the reels stop relative to win lines selected by the player. Originally, these machines were mechanical with physically rotating reels. In many modern slot machines, the mechanical reels have been replaced by “virtual reels displayed as spinning on a video display.

More recently, there has been a move towards implementing other types of games such as table games including poker, blackjack or roulette on electronic gaming machines. Motivations for doing so include that less staff may be required and games can be played more quickly when a human dealer or croupier is replaced by a gaming machine.

As such games are developed, there is a need to provide electronic display techniques which suit these game types.

### BRIEF SUMMARY OF THE INVENTION

In a first aspect, the invention provides a gaming system comprising:
a display;
a display controller arranged to control the display to display a manipulation area and to display one or more tokens; and
a token manipulator operable by a player to form a token set within the manipulation area from the one or more tokens.

In an embodiment, the token manipulator is operable by the player to move the token set outside of the manipulation area whereafter a function is executed in respect of the token set.

In an embodiment, the display controller controls the display to display a commitment area and the token manipulator is operable by the player to move the token set to the commitment area whereafter the function is executed in respect of the token set.

In an embodiment, the gaming system comprises a function executor for executing the function.

In an embodiment, the function executor is arranged to determine that the move of the token set to the commitment area has been completed and then automatically execute the function.

In an embodiment, the function executor is arranged to execute the function subsequent to receiving a confirmation input.

In an embodiment, the gaming system comprises a function selector for selecting the function to be executed.

In an embodiment, the function is to submit a bet.

In an embodiment, the function is to transfer tokens to another player.

In an embodiment, a plurality of function areas corresponding to different functions constitute the commitment area.

In an embodiment, the token manipulator comprises a stack former to allow a player to form a token set consisting of a stack of tokens.

In an embodiment, the token manipulator comprises a value indicator for indicating a current value of a token set.

In an embodiment, the display controller controls the display to display a token balance area and controls the display to at least initially display all of a player's tokens in the token balance area.

In an embodiment, the display controller is arranged to display tokens of different denominations separately.

In an embodiment, the token manipulator is operable to select an entire stack.

In an embodiment, the token manipulator is operable to select a single token of a stack.

In an embodiment, the token manipulator comprises a stack splitter operable by the player to split a stack of tokens.

In an embodiment, the token manipulator comprises a stack view changer operable by the player to change a view of the a stack of tokens.

In an embodiment, the display controller further displays a special function button operable by a player to perform a special function in relation to a token set.

In an embodiment, the display provides a touch screen display and the player manipulates the tokens by touching their representations on the touch screen display.

In an embodiment, the player moves a touched token by maintaining contact with the token until a desired new location for the token is reached.

In an embodiment, the gaming system comprises a pointing device operable to manipulate tokens.

In an embodiment, the gaming system comprises a plurality of buttons operable to manipulate tokens.

In an embodiment, the gaming system comprises a velocity vector calculator for calculating a velocity vector from a player movement relative to the touch screen display and wherein the token manipulator is arranged to move a touched token based on the calculated velocity.

In a second aspect, the invention provides a player interface for a gaming system comprising:
a display arranged to display a manipulation area and to display one or more tokens; and
a token manipulator operable by a player to form a token set within the manipulation area from the one or more tokens.

In an embodiment, the token manipulator is operable by the player to move the token set outside of the manipulation area whereafter a function is executed in respect of the token set.

In an embodiment, the display is arranged to display a commitment area and the token manipulator is operable by the player to move the token set to the commitment area whereafter the function is executed in respect of the token set.

In an embodiment, a plurality of function areas corresponding to different functions constitute the commitment area.

In an embodiment, the token manipulator comprises a stack former to allow a player to form a token set consisting of a stack of tokens.

In an embodiment, the token manipulator comprises a value indicator for indicating a current value of a token set.

In an embodiment, the display is arranged to display a token balance area which displays, at least initially, all of a player's tokens.

In an embodiment, the display is arranged to display tokens of different denominations separately.

In an embodiment, the token manipulator is operable to select an entire stack of tokens.

In an embodiment, the token manipulator is operable to select a single token of a stack of tokens.

In an embodiment, the token manipulator comprises a stack splitter operable by the player to split a stack of tokens.

In an embodiment, the token manipulator comprises a stack view changer operable by the player to change a view of the a stack of tokens.

In an embodiment, the display is arranged to display a special function button operable by a player to perform a special function in relation to a token set.

In an embodiment, the display is a touch screen display and the player manipulates the tokens by touching their representations on the touch screen display.

In an embodiment, the player moves a touched token by maintaining contact with the token until a desired new location for the token is reached.

In an embodiment, the player interface comprises a pointing device operable to manipulate tokens.

In an embodiment, the player interface comprises a plurality of buttons operable to manipulate tokens.

In a third aspect, the invention provides a method of gaming comprising:
displaying a manipulation area and one or more tokens on a display;
receiving one or more token manipulation instructions from a player; and
forming a token set within the manipulation area from the one or more tokens based on the one or more token manipulation instructions.

In an embodiment, the method comprises determining that the player has moved the token set outside of the manipulation area and subsequently executing a function in respect of the token set.

In an embodiment, the method comprises displaying a commitment area and determining that the player has moved the token set to the commitment area prior to the function being executed in respect of the token set.

In an embodiment, the method comprises automatically executing the function subsequent to determining that the move of the token set to the commitment area has been completed.

In an embodiment, the method comprises executing the function subsequent to receiving a confirmation input.

In an embodiment, the method comprises selecting the function to be executed.

In an embodiment, the method comprises forming a token set consisting of a stack of tokens.

In an embodiment, the method comprises indicating a current value of a token set.

In an embodiment, the method comprises controlling the display to display a token balance area and to at least initially display all of a player's tokens in the token balance area.

In an embodiment, the method comprises displaying tokens of different denominations separately.

In an embodiment, the method comprises further displaying a special function button operable by a player to perform a special function in relation to a token set.

In a fourth aspect, the invention provides computer program code which when executed by a computer causes the computer to implement the above method.

In a fifth aspect, the invention provides a computer readable medium comprising the above computer program code.

In a sixth aspect, the invention provides a data signal comprising the above computer program code.

In a seventh aspect, the invention provides transmitting or receiving the above computer program code.

### BRIEF DESCRIPTION OF SEVERAL VIEWS OF THE DRAWINGS

An embodiment of the invention will now be described in relation to the accompanying drawings in which:

FIG. 1 is a plan view of a gaming table of an embodiment;

FIG. 2 is a functional block diagram of a gaming system on an embodiment;

FIG. 3 is a further block diagram showing a manipulation processor in more detail;

FIG. 4 is a schematic diagram showing a networked embodiment;

FIG. 5 is a perspective view of a gaming machine in the form of a stand alone gaming machine;

FIG. 6 is a block diagram of a stand alone gaming machine;

FIG. 7 is a flow chart of the method of the embodiment;

FIG. 8 shows an exemplary player interface;

FIGS. 9 to 16 provide examples of building a bet;

FIG. 17 illustrates an example of cancelling a bet;

FIGS. 18 to 24 provide examples of selecting more than one token at once;

FIGS. 25 to 27 show special manipulation functions;

FIG. 28 illustrates one alternative control method; and

FIGS. 29 and 30 illustrate another alternative control model.

### DETAILED DESCRIPTION OF THE INVENTION

Referring to the drawings, there is shown a gaming system arranged to implement a gaming system with a token manipulator. In one embodiment, the gaming system is implemented as a virtual gaming table, where a horizontally oriented touch screen display is used by players to participate in a game but may also be implemented as a gaming machine. The gaming system can take a number of different forms.

In a first form, a stand alone gaming table or a gaming machine is provided wherein all or most components required for implementing the game are present or located next to a player operable virtual gaming table.

In a second form, a distributed architecture is provided wherein some of the components required for implementing the game are located at the gaming table or gaming machine and some of the components are located remotely. For example, a “thick client” architecture may be used wherein part of the game is executed locally by the player operable gaming table and part of the game is executed remotely, such as by a gaming server; or a “thin client” architecture may be used wherein most of the game is executed remotely such as by a gaming server and a player operable gaming table is used only to display audible and/or visible gaming information to the player and receive gaming inputs from the player.

However, it will be understood that other arrangements are envisaged. For example, an architecture may be provided wherein a gaming table is networked to a gaming server and the respective functions of the gaming table and the gaming server are selectively modifiable. For example, the gaming system may operate in stand alone gaming table mode, “thick client” mode or “thin client” mode depending on the game being played, operating conditions, and so on. Other variations will be apparent to persons skilled in the art.

Persons skilled in the art will appreciate that the reference to random numbers includes pseudo-random numbers.

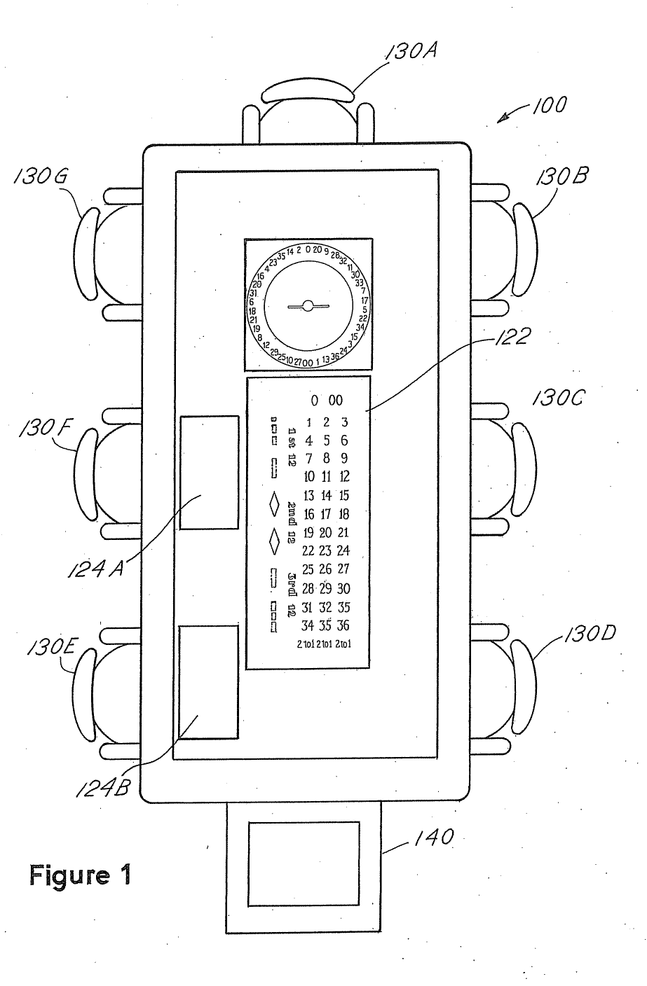

FIG. 1 is a plan view of a virtual gaming table 100 having a horizontally oriented display 120 and a log-on terminal 140. As can been from FIG. 1, the gaming table is surrounded by seven chairs 130 indicating seven possible player positions. Two player interfaces 124a, 124b are active on the display 120. A central area 122 of the display is used to display information common to all players; in the example shown in FIG. 1 a display of a roulette game.

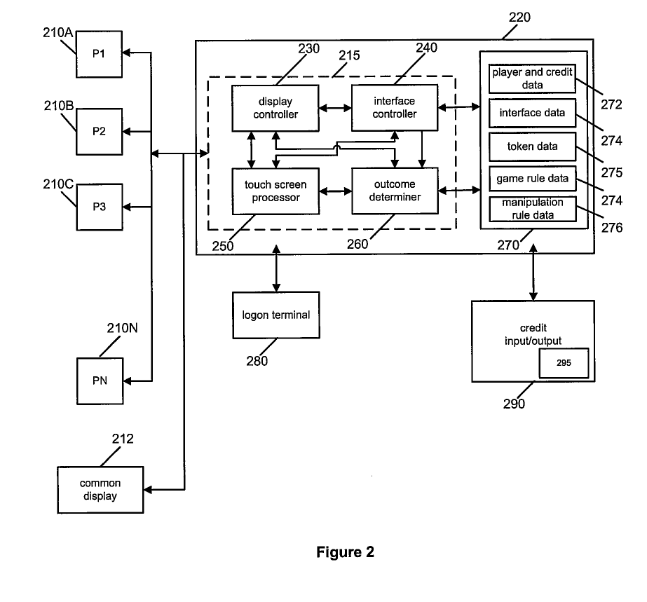

As shown in FIG. 2, from a functional perspective, a virtual table 200 comprises a game controller 220, a common display 212 and a variable number of player interfaces 210. As described in detail below, in the embodiment the number of player interfaces depends on the number of players playing the game. In some embodiments there may be a single player interface for each player so that each time a player enters the game an interface is added. In other embodiments, a minimum number of player interfaces may always be displayed even though it is possible they are not all being used and additional player interfaces added as necessary, when the minimum is exceeded; unused interfaces may function in an attract mode. In further embodiments, a player may request an additional player interface. For example, some players may wish to play two hands of cards simultaneously where the gaming table implements a card game.

In the embodiment, a number of modules are implemented by a processor 215. However, a person skilled in the art will appreciate that dedicated hardware could be used instead of program code running on a processor 215 to implement the required functions.

The game controller's processor 215 typically processes the game play instructions in accordance with game play rules and outputs game play outcomes to the display. Typically, the game play instructions are stored as program code in a memory. Herein the term “processor” is used to refer generically to any device that can process game play instructions in accordance with game play rules and may include: a microprocessor, microcontroller, programmable logic device or other computational device, a general purpose computer (e.g. a PC) or a server.

These functions are carried out based on data such as player and credit data 272 and game rule data 274 stored in a memory 270 of the game controller 220. The game controller 220 has a display controller 230 for controlling what is displayed both in the common display area 212 of a gaming table 212 and on each of the player interfaces 210.

The display 120 incorporates a touch screen. Herein such a display is referred to as “touch screen display”. Accordingly, it will be appreciated that the player interfaces share a common display 120. A person skilled in the art will appreciate that the “touch screen” sensor need not cover the entire display. For example central area 122 as shown in FIG. 1 need not necessarily have a touch screen capability. The touch screen is a multi-touch screen capable of processing simultaneous or near simultaneous instructions from a number of different players. The display 120 itself is typically a wide screen, large format display such as a plasma or LCD display of a size in the order of 80-120 inches (2 m-3 m) across the diagonal. However, a person skilled in the art will appreciate that the display could be formed a plurality of display sub-units located adjacent to one another under the control of the display controller 230 to display both the player interfaces 210 and the common display area 212.

The display controller 230 controls the display to display the individual player interfaces based on data provided by the interface controller 240 and the outcome determiner 260. The interface controller 240 also provides data to the touch screen processor 250 to enable it to interpret touches on the touch screen display in order to associate them with individual player interfaces 210 and to provide this data to the outcome determiner 260. In this manner, individual player instructions can be correctly provided to the outcome determiner 260 so that the outcome determiner 266 can determine the result of the game based on the game rule data 274. Similarly, the outcome determiner 260 provides data to the display controller 230 regarding the game outcomes for individual players. This may be displayed in a display region of the player interface 210 on the common display or both.

A person skilled in the art will appreciate that depending on the game, the outcome determiner may determine independent results for each player such as in a game like roulette or results that depend on the game play of other players such as in a competitive game like poker. Credit data 272 is maintained separately for each player interface in memory 270. That data may be associated with a specific player and the players identity captured either via the log-on terminal 280 or by other means as will be described in further detail. The log-on terminal 280 typically includes a touch screen display allowing a player to enter their name and assign to themselves a player position number. Alternatively the player position maybe assigned by the game system. In alternative embodiments, players may be assigned positions anonymously by providing them with a temporary access code, printed by the log-on terminal on a voucher. In other embodiments, a player position is allocated by determining a player's position relative to the table.

To participate in the game a player uses the log-on terminal 280 to request a player interface for the game either manually, or by swiping or otherwise providing a player tracking device to the log-on terminal 280. That is, depending on the embodiment the log-on terminal may read magnetic cards, smart cards, or RFID tags or the like.

The player may also use the log-on terminal to log out of the game or alternatively may operate the player interface to log out of the game.

A credit input/output mechanism 290 can either be provided centrally, for example in association with the log-on terminal so that the player enters credit when they log-on to the game. A credit mechanism can also be provided at each player position. For example, by a bill acceptor located under the table.

In one embodiment, the credit input/output mechanism includes a voucher printer 295. A player provides credit to the credit input/output 290 by inputting currency using a bill or coin acceptor. The credit mechanism 290 creates a record in credit data 272 having an access code. A voucher is printed by a voucher printer 295. The voucher has the code on it so that the player can enter at the player interface 210 using a virtual key pad. The game controller 220 processes the input code and verifies it against records stored as credit data 272. If the code is verified, the amount of credit is associated with the player interface used to enter the code.

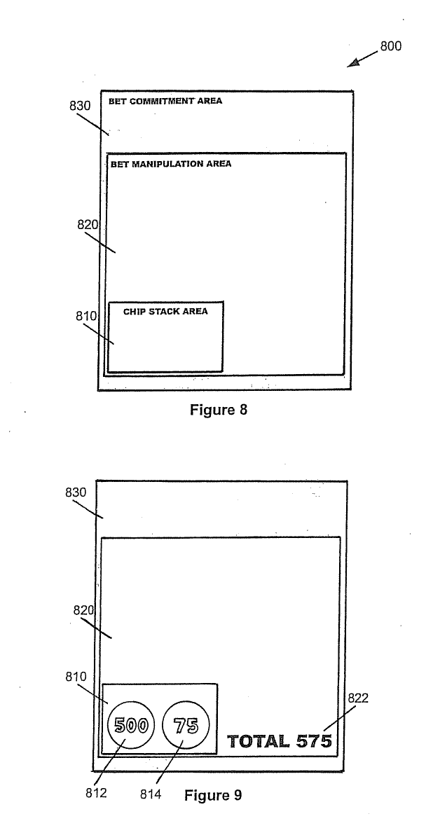

FIG. 8 shows a typical player interface 800 having a chip stack area 810, a bet manipulation 820 and a bet commitment area 830. Accordingly, bet commitment is an example of function that is carried out in respect of gaming tokens. The most common example of a “token” is a chip. However, other tokens such as coins, bank notes or the like may be employed. That is, once tokens are moved to this area the bet is committed or placed. Tokens can be manipulated within the bet manipulation area to form them into token sets before they are moved to the bet commitment area. Other functions can be carried out by moving the tokens from the bet manipulation to another function area. An example is that in some embodiments moving chips to a designated area “passes” the chips to another player by causing the chips to be re-allocated to that player.

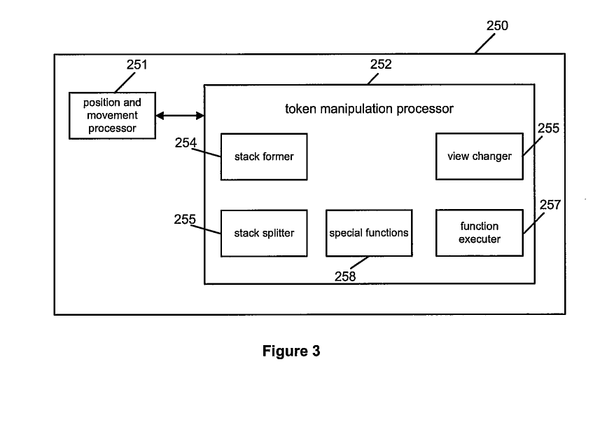

With reference to FIG. 2, the interface controller provides to the display controller, data stored as interface data 273 which specifies which parts of the player interface are assigned to the different areas 810, 820, 830 so that these areas are displayed to a player. Token data 275 specifies the number of a tokens associated with a player interface and their current locations within the player interface 800. The touch screen processor 250 determines when a player touches their player interface and employs the token data to determine which token or tokens the player has touched. In embodiments of the present invention, a player moves a token by touching the touch screen in the vicinity of token and dragging their finger across the screen to a new position. When the player releases or removes their finger from the touch screen the movement is completed. Referring to FIG. 3, there is shown detail of the touch screen processor 250. The touch screen processor 250 incorporates a position and movement processor 251 for processing raw data from the touch screen display to generate date specifying where the user has touched the screen.

In an alternative mode of control, the position and movement processor 251 is configured to detect the speed at which a player moves their hand relative to the screen such that a player can “flick” a token by rapidly moving their finger in a direction they wish the chip to go to impart a vector velocity to the chip. The position and movement processor 251 dampens the movement such that the movement cause by a “flick” makes “sense” within the context of the user interface, eg. so that the tokens do not travel too far.

The token manipulation processor 252, implements manipulation rules 276 based on the data received from the movement and position processor 259. One function implemented by the manipulation processor 252 is the stack former 254 which acts to group tokens together into a stack. For example if two chips are separately moved into the manipulation area 820 and placed so that they overlap, the stack former 254 is arranged to group the chips together to form a token stack. The stack splitter 255 is arranged to split a token stack in the following examples. The manipulation processor 252 updates the token data 275 to specify whether tokens are grouped or ungrouped and where the tokens are located with respect to the player interface at any particular period of time. Thus, the manipulation processor 252 in conjunction with the player interface and movement and position processor 251 provide a token manipulator operable by the player to manipulate tokens.

A view changer 256, as described in more detail below, allows the player to switch between a plan and a side view of a pile of tokens in order to manipulate them using the stack splitter function. The function executer 257 carries out functions, for example a bet commitment function as described in more detail below. A special function processor 258 implements additional functions.

In this embodiment there is no limit on the number of stacks of chips that can be provided in bet manipulation area 820 other than the practical limits set by the size of the manipulation area or the number of chips the player has available. Each stack could consist of a single chip. In one implementation, the arrangement of the chip stacks in the bet manipulation area is automatically optimized after a player action. Such optimizations could consist of arranging the stacks of chips in a orthogonal arrangement, i.e. into rows and columns of stacks that are aligned vertically and/or horizontally or sorting the stacked of chips so that the largest stack of chips in the manipulation area is left most.

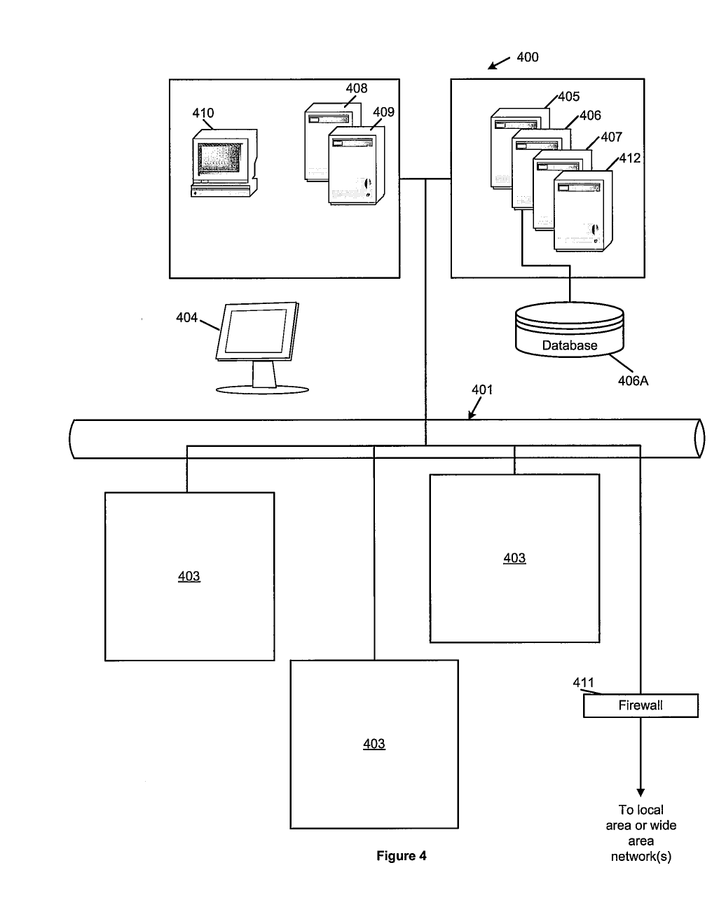

FIG. 4 shows a gaming system 400 in accordance with an alternative embodiment. The gaming system 400 includes a network 401, which for example may be an Ethernet network. Gaming tables 403, are connected to the network 401. The gaming tables 202 provide a player operable interface for the gaming system 400.

One or more displays 404 may also be connected to the network 401. The displays 404 may, for example, be associated with one or more gaming tables 203. The displays 404 may be used to display representations associated with game play on the gaming tables 402, and/or used to display other representations, for example promotional or informational material.

In a thick client embodiment, game server 405 implements part of the game played by a players using a gaming table 403 and the gaming machine 403 implements part of the game. With this embodiment, as both the game server and the gaming device implement part of the game, they collectively provide a game controller. A database management server 406 may manage storage of game programs and associated data for downloading or access by the gaming devices 402 in a database 406A. Typically, if the gaming system enables players to participate in a Jackpot game, a Jackpot server 407 will be provided to monitor and carry out the Jackpot game. A loyalty program server 412 implements a loyalty program.

In a thin client embodiment (or networked gaming embodiment), game server 405 implements most or all of the game played by a player using a gaming table 403 and the gaming table 403 essentially provides only the player interface. With this embodiment, the game server 405 provides the game controller. The gaming table 403 will receive player instructions, pass these to the game server 405 which will process them and return game play outcomes to the gaming table 403 for display.

Servers are also typically provided to assist in the administration of the gaming network 400, including for example a gaming floor management server 408, and a licensing server 409 to monitor the use of licenses relating to particular games. An administrator terminal 410 is provided to allow an administrator to run the network 401 and the devices connected to the network.

The gaming network 400 may communicate with other gaming systems, other local networks, for example a corporate network, and/or a wide area network such as the Internet, for example through a firewall 411.

Persons skilled in the art will appreciate that in accordance with known techniques, functionality at the server side of the network may be distributed over a plurality of different computers. For example, elements may be run as a single “engine” on one server or a separate server may be provided. For example, the game server 405 could run a random generator engine. Alternatively, a separate random number generator server could be provided. Further, persons skilled in the art will appreciate that a plurality of games servers could be provided to run different games or a single game server may run a plurality of different games as required by the tables 403.

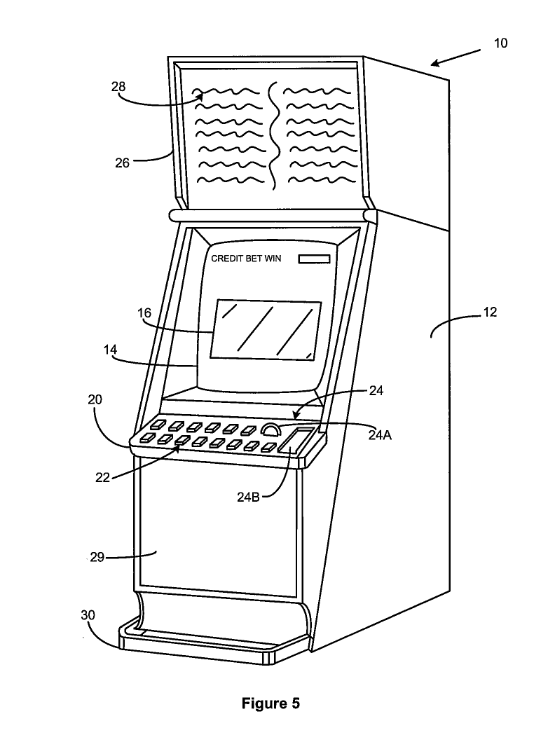

A gaming system in the form of a stand alone gaming machine 10 is illustrated in FIG. 5 which may be configured to implement a video poker game for example. A person skilled in the art will appreciate that in such an embodiment, the gaming machine can implement the same functions as illustrated in FIGS. 2 and 3 with the exception that it is not required to control multiple interfaces. The gaming machine 10 includes a console 12 having a display 14 on which is displayed representations of a game 16 that can be played by a player. A mid-trim 20 of the gaming machine 10 houses a bank of buttons 22 for enabling a player to interact with the gaming machine, in particular during game play. The mid-trim 20 also houses a credit input mechanism 24 which in this example includes a coin input chute 24A and a bill collector 24B. Other credit input mechanisms may also be employed, for example, a card reader for reading a smart card, debit card or credit card. A reading device may also be provided for the purpose of reading a player tracking device, for example as part of a loyalty program. The player tracking device may be in the form of a card, flash drive or any other portable storage medium capable of being read by the reading device.

A top box 26 may carry artwork 28, including for example pay tables and details of bonus awards and other information or images relating to the game. Further artwork and/or information may be provided on a front panel 29 of the console 12. A coin tray 30 is mounted beneath the front panel 29 for dispensing cash payouts from the gaming machine 10.

The display 14 shown in FIG. 5 is in the form of a video display unit, particularly a cathode ray tube screen device. Alternatively, the display 14 may be a liquid crystal display, plasma screen, any other suitable video display unit. The top box 26 may also include a display, for example a video display unit, which may be of the same type as the display 14, or of a different type.

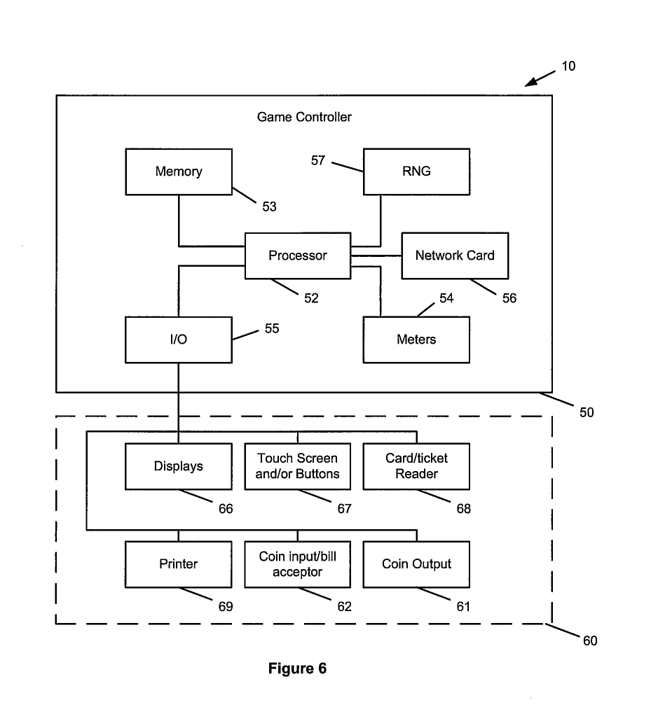

FIG. 6 shows a block diagram of operative components of a typical gaming machine 10. The gaming machine 10 includes a game controller 50 having a processor 52. Instructions and data to control operation of the processor 50 are stored in a memory 53, which is in data communication with the processor 52. Typically, the gaming machine 10 will include both volatile and non-volatile memory and more than one of each type of memory, with such memories being collectively represented by the memory 53.

The gaming machine has hardware meters 54 for purposes including ensuring regulatory compliance and monitoring player credit, an input/output (I/O) interface 55 for communicating with peripheral devices of the gaming machine 100. The input/output interface 55 and/or the peripheral devices may be intelligent devices with their own memory for storing associated instructions and data for use with the input/output interface or the peripheral devices. A random number generator module 57 generates random numbers for use by the processor 52. Persons skilled in the art will appreciate that the reference to random numbers includes pseudo-random numbers.

In the example shown in FIG. 6, a player interface 60 includes peripheral devices that communicate with the game controller 50 comprise one or more displays 66, a touch screen and/or buttons 67, a card and/or ticket reader 68, a printer 69, a bill acceptor and/or coin input mechanism 62 and a coin output mechanism 61. Additional hardware may be included as part of the gaming machine 10, or hardware may be omitted as required for the specific implementation.

In addition, the gaming machine 10 may include a communications interface, for example a network card 56. The network card may, for example, send status information, accounting information or other information to a central controller, server or database and receive data or commands from the central controller, server or database.

It is also possible for the operative components of the gaming machine 10 to be distributed, for example input/output devices 66,67,68,69,62,61 to be provided remotely from the game controller 50.

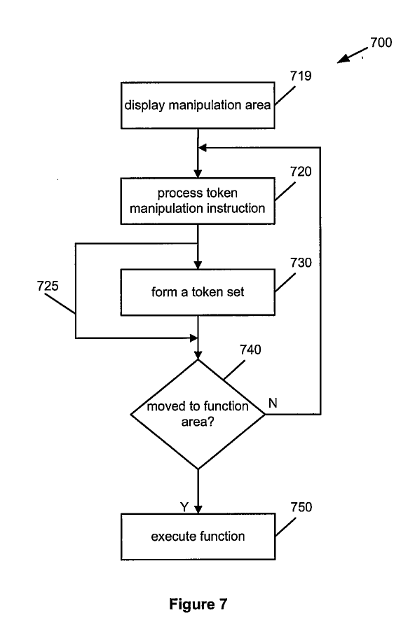

FIG. 7 shows a method of the embodiment. The manipulation area is displayed to the user 710. Manipulation instructions are processed 720. Typically a token set is formed 730 within the manipulation area based on the initial manipulation instructions, although this step may be bypassed 725. If tokens are moved to a commitment area 740 the function is executed 750 in respect of the token set moved to that area. Otherwise the process allows the player to continue by making further manipulations.

A person skilled in the art will also appreciate that the invention can be extended to other games such as Black Jack, Roulette, “Big Wheel”, Sic-Bo and Baccarat. For Roulette, the bet manipulation area can be used as a staging area during the time when no bets are possible allowing a person to prepare his bet or bets for the next game. For Black Jack the movement of virtual chips with a touch screen can be used as a substitute for having to press a button such as “double down” button, instead a player would move his chips from the stack into the bet area.

A person skilled in the art will appreciate that while the above technique advantageously employs touch screen technology, other controller devices such as a pointing device could be used to manipulate the tokens. Similarly, navigation buttons in combination with one or more action buttons to could be employed.

A person skilled in the art will appreciate that the above touch screen based techniques could be provided in conjunction with a conventional technology for allowing a player to select bet types in order that they can have the choice as to how they manipulate chips.

A person skilled in the art will appreciate that while the above embodiments describe moving chips into a commitment area before a function is committed. In some embodiments, simply moving the tokens outside of the manipulation area could cause a function to be executed in respect of the token sets.

In other embodiments, the person skilled in the art will appreciate that a player may be required to confirm an action. For example, if there is some doubt as to whether a player has moved their chips outside of the area, such as when 90% of the area of chips has been moved into the commitment area, a player may be asked to confirm their instructions.

### EXAMPLES

### Example 1

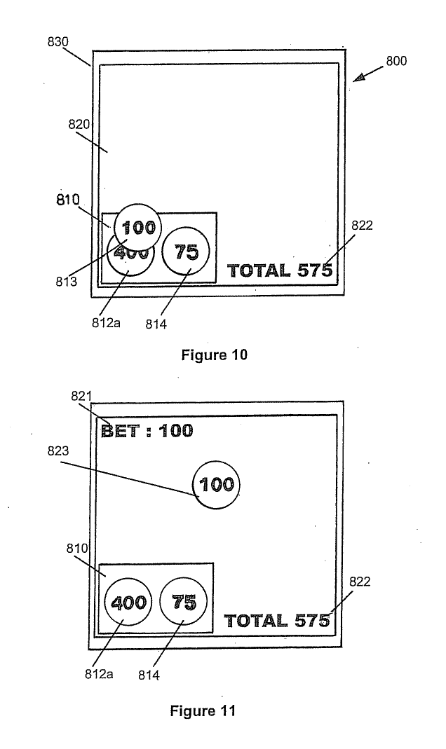

FIGS. 9 to 16 are examples of how a player can build a bet using the technique of the embodiment. In FIG. 9, the player has a chip stack area 810 that displays the players token balance and where the chips are initially arranged. A person skilled in the art will appreciate that the chip stack area effectively provides a sub-area of the manipulation area in this embodiment where “un-manipulated” chips are located. A person skilled in the art will appreciate that provided sufficient space is provided within the manipulation area 820 to separate out chips from those of a player's original chip stack, a separate chip stack area need not be provided. In the example of FIG. 9, a player has 575 chips as indicated by total counter 822. Initially, these are split into the first pile of five “100” denomination chips 812 and a second pile of three “25” denomination chips. In this example, the player wishes to make a bet of 125. The player touches the stack of 100 chips on the left and holding his finger down, moves his finger across the touch screen as indicated in FIG. 10, this causes one chip 813 to become detached from the pile of 100 chips which is revised to show a total of 400 in 100 denomination chips 812a.

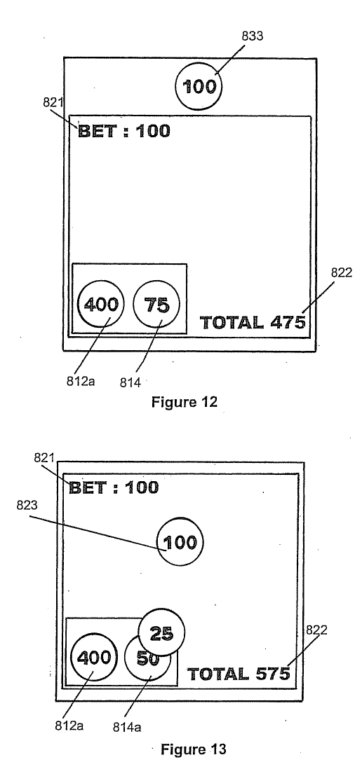

Once the player moves the token to the manipulation area, as shown in FIG. 11 the token forms an initial token set 823 of a total of 100. A bet indicator 821 is added at this point to indicate that the player has a bet of 100. Note that the player could have moved the token directly to the commitment area 830 should he have chosen to commit the bet immediately as shown as a possible scenario in FIG. 12. However in the present example, the player wishes to place a bet of 125 accordingly as shown in FIG. 13, the player places his finger on the stack of chips 814 and starts to move a 25 denomination chip 815 into the manipulation area.

It is important to note that in some games the player is only able to make a bet in one motion. That is, moving two chips into play in two separate motions is called a “string” bet and is illegal. Therefore, for such games it is important that there is bet manipulation area that allows a player to manipulate bets separately from the action of finalising a bet for the player to build bets comprised of multiple chips.

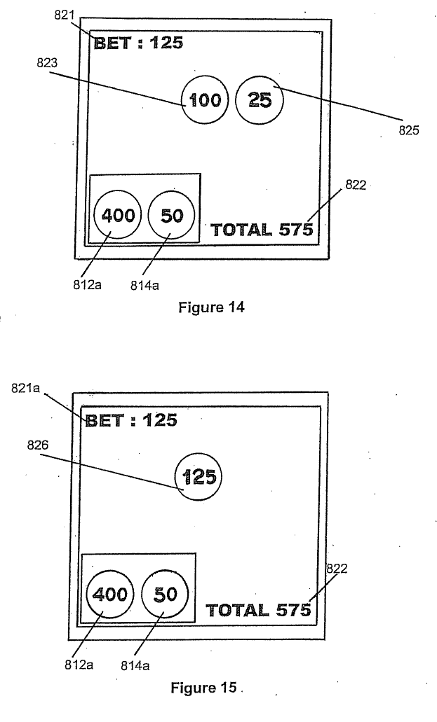

The player has a number of options. He could continue to move his finger from the position illustrated in FIG. 13 via the position of chip 815 to outside the manipulation area causing him to commit a bet of 25. In this case the 100 chip would be automatically returned to the chip stack. Alternatively, the player could move his finger until the 25 chip is at rest 825 somewhere else inside the manipulation area as indicated in FIG. 14. Note that the bet amount 821a has been updated to a total of 125 to indicate that total number of units within the bet manipulation area. Thus it will be apparent that the bet manipulation area is a work area for the player. The player can move chips within this area with this finger however he likes. In situations where other players can see his manipulation area, the player can play with his chips much like players do with real chips. As shown in FIG. 15, the player subsequently moves the 25 chip so that it overlaps the 100 chip 823 so that a new token set 826 is formed as illustrated in FIG. 15. That is, the two chips are combined into a single value “125” chip, representing the stack of both chips: a “token set”. A person skilled in the art will appreciate that this 125 chip could be shown in a perspective or 3D view instead of a plan view as in FIG. 15. The stack can be represented in a number of different ways. For example the 125 chip could be represented by an inner disk and an outer concentric ring, each which could be different colours representing different denominations that make up the chip. Further, a 100 denomination chip could be shown as being larger than a 25 denomination chip.

A person skilled in the art will appreciate that the stack former 254 of FIG. 3 judges when the chips overlap sufficiently for it to determine that a stack should be formed. Once the stack has been formed, these chips are effectively grouped for further manipulation unless they are subsequently split using one of the techniques described below.

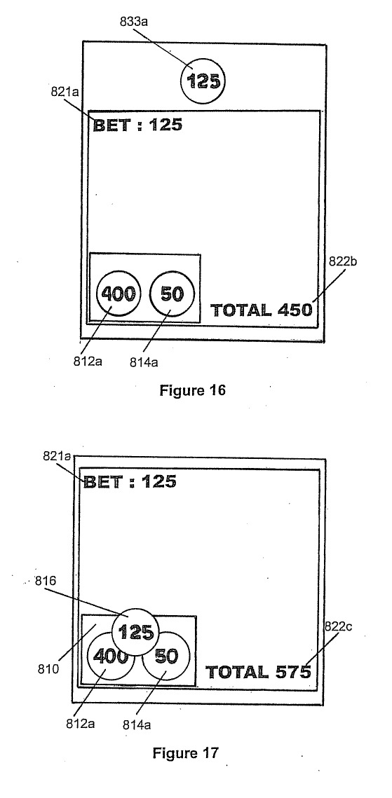

As indicated in FIG. 16, the player can move the “125 chip” 820 to the commitment area 830 where it is shown a committed bet 833a. As can be seen from FIG. 16, the players total 822b is updated to show that the player has 450 chips left. In order to cancel a bet, a player moves the token set back 816 to the chips stack area 810 as illustrated in FIG. 17.

Note that in this example, the chip stack area is arranged so that no matter where the 125 chip is placed within the chip stack area, it is automatically split up and added to the correct piles such that once the player removes his finger from the screen, the screen reverts to the position shown in FIG. 9.

### Example 2

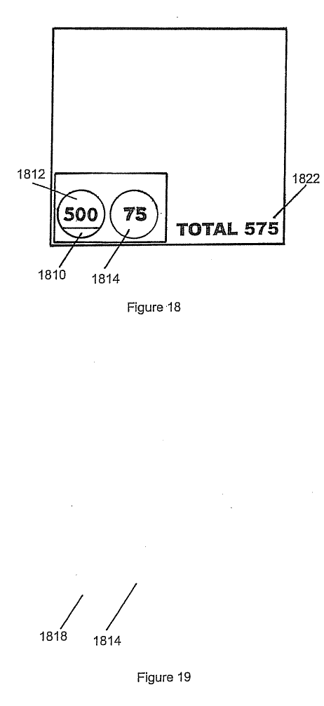

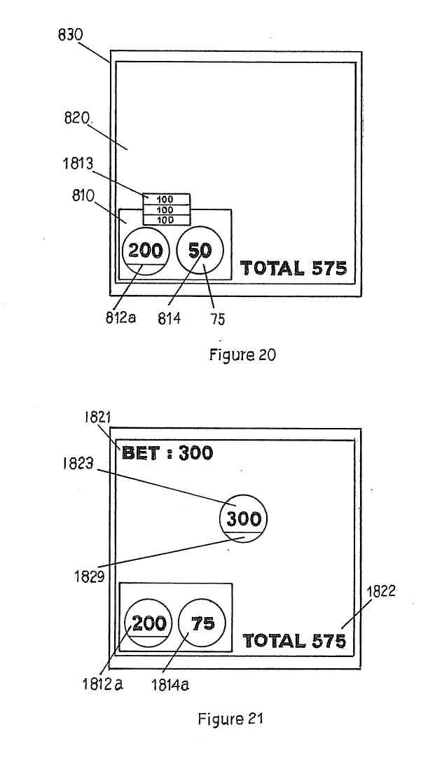

Example 2 illustrates how a player can manipulate more than one chip at one time. Referring to FIG. 18, a stack of five 100 chips 812 includes a view change “hot spot” 819. Touching this segment activates the view changer 256, to display the stack of chips in side view 818 as shown in FIG. 19. A player places their finger so as to touch the third chip from the top. In this manner the top three chips are selected as indicated by moving chip stack 813 in FIG. 20. That is, the player only needs to touch one of the chips to move a pile of three chips. As indicated in FIG. 21, the player then has a bet amount 1821 and a token or chip set 1823 valued at 300 chips displayed in the manipulation area. Note that this stack of chips still contains a hot spot 1829 indicating that a player can change the view by manipulating them.

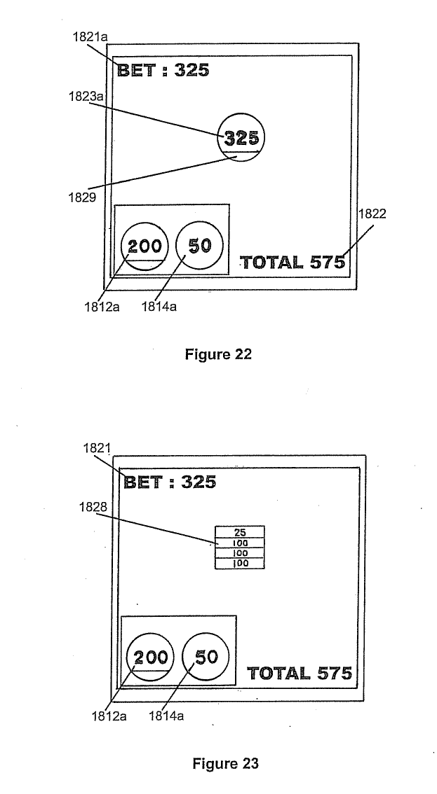

As shown FIG. 22, a player can drag a 25 chip from the stack 814a to the set of chips 823a. The view change hotspot 1829 is still present and the bet mount is updated 1821a.

In FIG. 23, a player has activated the hot spot to change to the side view 1828 in respect of the set of chips. Note that in this case the 25 chip is a different colour to the 100 chip. This allows the invention to be implemented without a number being shown on the side of each chip.

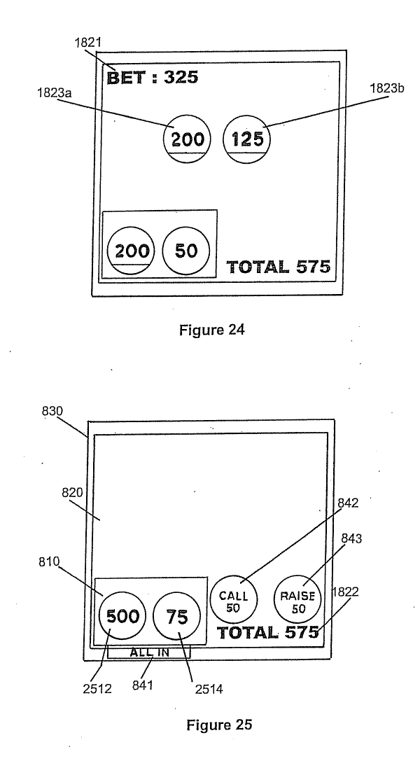

As described in relation to FIG. 20, the player can split the chip stack by selecting one of the chips so that the stack is divided into chips comprising the lowest chip touched by the player and the other chips. In this case the stack is split into two stacks 1823a of 200 chips and 1823b of 125 chips as illustrated in FIG. 24. A person skilled in the art will appreciate that these chips can be split again or moved in some other manner.

### Example 3

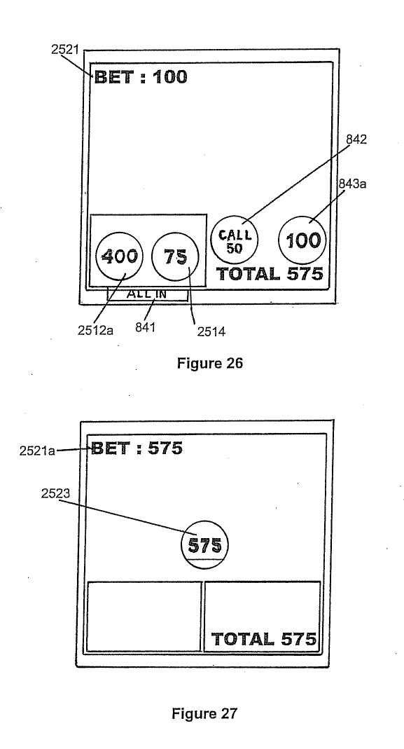

In some games such as Poker or Black Jack there are times when the player can be offered special functions that save time without compromising the player experience. In this example, three additional special functions are present in the form of an “all-in” button 841, a “call” button 842 and a raise button 843. Each button displayed graphically on the player user interface 810. In this display the player initially has five 100 chips 2512 and three 25 chips 2514. In this example a bet of 50 has been made by an opposing player. In such a situation, the player needs to decide whether to make a call, raise, or fold. If the player wants to make a call he can simply touch the call 50 button represented as a chip which will create a virtual chip of the correct value to make a call a bet. In this case a value of 50. Similarly if the player wants to make a minimum raise, eg. raise 50, the player touches the raise button 843. Note once the special button is touched, it changes to represent the actual chip value and the chip stacks are adjusted accordingly. Prior to this the chip stacks are not adjusted because the special chips do not have the value until touched. So, if the raise 50 chip is selected, the display of FIG. 26 is shown where the raise chip has been changed so that there is a display of 100 chip 843a and the bet amount 2521 is updated to show 100. Similarly, the chip stack 2512a has been modified to show only 400 chips. It should be noted that as in the previous examples, the bet is not binding to the chip leaves the bet manipulation area. Plus the player at this point could perform further manipulation.

A third special function is drawn as a bar on the display in FIG. 25 is an “all-in” button 841. If the player touches and drags this finger on the screen from this bar it causes all of the chips in his stack to be moved into the bet manipulation area. Then if the chip stack is dragged outside the box into the commitment area the bet is committed. Once the all in button is pushed, the 575 chip stacks 2512 and 2514 shown in FIG. 5 emerged in a single stack 2523 as shown in FIG. 27.

### Example 4

During the selection of multiple chips an alternative could be provided in the form of an indicator 820 as illustrated in FIG. 28; in order to allow a player to split a stack 2810 of chips by moving their finger over the indicator 2820 until it reaches a position where they can provide the desired splitting of the stack. The value that will be split off the stack can be displayed 2830 to the player.

### Example 5

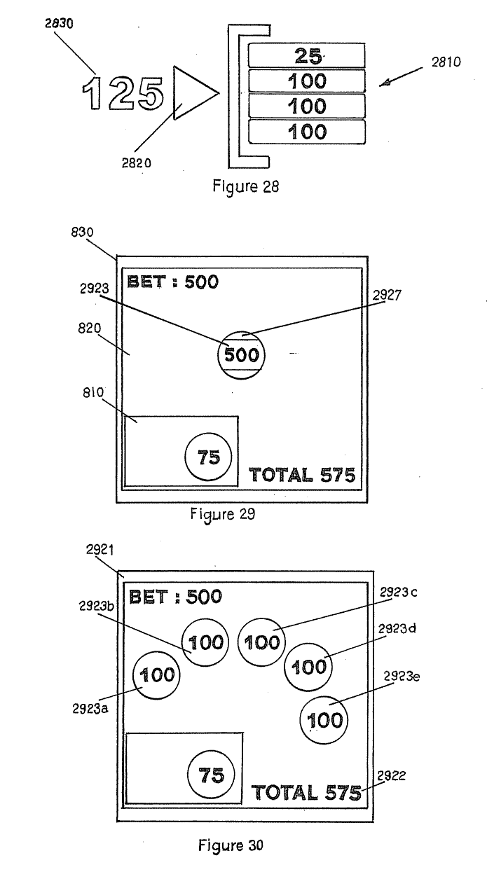

A further technique for splitting a stack of chips shown in FIG. 29, where a player has placed a stack of 500 chips 2923 to form a token set in the manipulation area and the bet amount of 500 is shown as 2921. An additional stack split hot spot is placed on the top of the chip 2927. If the player touches the hotspot 2927, the chip image could be split or “coloured down” to the next lowest denomination. In this case this would be 5×100 denomination chips as indicated in FIG. 30 where there are five 100 chips 2923a to 2923e.

If the stack is mixed, a stack can either be split in accordance with certain rules—e.g. to split the 125 chips from one another or different options can be presented to the player to split the chips based on the available denominations. For example, an alternative denomination may be 250 and accordingly a player may be offered the opportunity to split the stack into five 100 chips and three 25 chips or two 250 chips and three 25 chips.

Various other modifications will be apparent to a person skilled in the art and should be considered as falling within the scope of the invention described herein. In particular, features of the above embodiments and examples can be combined to form further embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that the reference to prior art herein does not constitute an admission that the prior art forms a part of the common general knowledge in the art.

1. A gaming system comprising:
a display;
a display controller arranged to control the display to display a manipulation area and to display one or more tokens; and
a token manipulator operable by a player to form a token set within the manipulation area from the one or more tokens.

2. A gaming system as claimed in claim 1, wherein the token manipulator is operable by the player to move the token set outside of the manipulation area whereafter a function is executed in respect of the token set.

3. A gaming system as claimed in claim 2, wherein the display controller controls the display to display a commitment area and the token manipulator is operable by the player to move the token set to the commitment area whereafter the function is executed in respect of the token set.

4. A gaming system as claimed in claim 2, comprising a function executor for executing the function.

5. A gaming system as claimed in claim 4, wherein the function executor is arranged to determine that the move of the token set to the commitment area has been completed and then automatically execute the function.

6. A gaming system as claimed in claim 4, wherein the function executor is arranged to execute the function subsequent to receiving a confirmation input.

7. A gaming system as claimed in claim 2, comprising a function selector for selecting the function to be executed.

8. A gaming system as claimed in claim 2, wherein the function is to submit a bet.

9. A gaming system as claimed in claim 2, wherein the function is to transfer tokens to another player.

10. A gaming system as claimed in claim 3, wherein a plurality of function areas corresponding to different functions constitute the commitment area.

11. A gaming system as claimed in claim 1, wherein the token manipulator comprises a stack former to allow a player to form a token set consisting of a stack of tokens.

12. A gaming system as claimed in claim 1, wherein the token manipulator comprises a value indicator for indicating a current value of a token set.

13. A gaming system as claimed in claim 1, wherein the display controller controls the display to display a token balance area and controls the display to at least initially display all of a player's tokens in the token balance area.

14. A gaming system as claimed in claim 13, wherein the display controller is arranged to display tokens of different denominations separately.

15. A gaming system as claimed in claim 11, wherein the token manipulator is operable to select an entire stack.

16. A gaming system as claimed in claim 11, wherein the token manipulator is operable to select a single token of a stack.

17. A gaming system as claimed in claim 11, wherein the token manipulator comprises a stack splitter operable by the player to split a stack of tokens.

18. A gaming system as claimed in claim 11, wherein the token manipulator comprises a stack view changer operable by the player to change a view of the a stack of tokens.

19. A gaming system as claimed in claim 1, wherein the display controller further displays a special function button operable by a player to perform a special function in relation to a token set.

20. A gaming system as claimed in claim 1, wherein the display provides a touch screen display and the player manipulates the tokens by touching their representations on the touch screen display.

21. A gaming system as claimed in claim 20, wherein the player moves a touched token by maintaining contact with the token until a desired new location for the token is reached.

22. A gaming system as claimed in claim 1, comprising a pointing device operable to manipulate tokens.

23. A gaming system as claimed in claim 1, comprising a plurality of buttons operable to manipulate tokens.

24. A gaming system as claimed in claim 20, comprising a velocity vector calculator for calculating a velocity vector from a player movement relative to the touch screen display and wherein the token manipulator is arranged to move a touched token based on the calculated velocity.

25. A player interface for a gaming system comprising:
a display arranged to display a manipulation area and to display one or more tokens; and
a token manipulator operable by a player to form a token set within the manipulation area from the one or more tokens.

26. A player interface as claimed in claim 25, wherein the token manipulator is operable by the player to move the token set outside of the manipulation area whereafter a function is executed in respect of the token set.

27. A player interface as claimed in claim 26, wherein the display is arranged to display a commitment area and the token manipulator is operable by the player to move the token set to the commitment area whereafter the function is executed in respect of the token set.

28. A player interface as claimed in claim 27, wherein a plurality of function areas corresponding to different functions constitute the commitment area.

29. A player interface as claimed in claim 25, wherein the token manipulator comprises a stack former to allow a player to form a token set consisting of a stack of tokens.

30. A player interface as claimed in claim 25, wherein the token manipulator comprises a value indicator for indicating a current value of a token set.

31. A player interface as claimed in claim 25, wherein the display is arranged to display a token balance area which displays, at least initially, all of a player's tokens.

32. A player interface as claimed in claim 31, wherein the display is arranged to display tokens of different denominations separately.

33. A player interface as claimed in claim 29, wherein the token manipulator is operable to select an entire stack of tokens.

34. A player interface as claimed in claim 29, wherein the token manipulator is operable to select a single token of a stack of tokens.

35. A player interface as claimed in claim 29, wherein the token manipulator comprises a stack splitter operable by the player to split a stack of tokens.

36. A player interface claimed in claim 29, wherein the token manipulator comprises a stack view changer operable by the player to change a view of the a stack of tokens.

37. A player interface as claimed in claim 25, wherein the display is arranged to display a special function button operable by a player to perform a special function in relation to a token set.

38. A player interface as claimed in claim 25, wherein the display is a touch screen display and the player manipulates the tokens by touching their representations on the touch screen display.

39. A player interface as claimed in claim 38, wherein the player moves a touched token by maintaining contact with the token until a desired new location for the token is reached.

39. A player interface as claimed in claim 25, comprising a pointing device operable to manipulate tokens.

40. A player interface as claimed in claim 25, comprising a plurality of buttons operable to manipulate tokens.

41. A method of gaming comprising:
displaying a manipulation area and one or more tokens on a display;
receiving one or more token manipulation instructions from a player; and
forming a token set within the manipulation area from the one or more tokens based on the one or more token manipulation instructions.

42. A method as claimed in claim 41, comprising determining that the player has moved the token set outside of the manipulation area and subsequently executing a function in respect of the token set.

43. A method as claimed in claim 42, comprising displaying a commitment area and determining that the player has moved the token set to the commitment area prior to the function being executed in respect of the token set.

44. A method as claimed in claim 43, comprising automatically executing the function subsequent to determining that the move of the token set to the commitment area has been completed.

45. A method as claimed in claim 43, comprising executing the function subsequent to receiving a confirmation input.

46. A method as claimed in claim 42, comprising selecting the function to be executed.

47. A method as claimed in claim 41, comprising forming a token set consisting of a stack of tokens.

48. A method as claimed in claim 41, comprising indicating a current value of a token set.

49. A method as claimed in claim 41, comprising controlling the display to display a token balance area and to at least initially display all of a player's tokens in the token balance area.

50. A method as claimed in claim 49, comprising displaying tokens of different denominations separately.

51. A method as claimed in claim 40, comprising further displaying a special function button operable by a player to perform a special function in relation to a token set.

52. A method as claimed in claim 40, and including computer program code, and further comprising executing said computer program code for carrying out said method.

53. A method as claimed in claim 52 and further including a computer readable medium comprising said computer program code.

54. A method as claimed in claim 52 and further including a data signal comprising said computer program code.

55. A method as claimed in claim 52, and further comprising transmitting said computer program code.

56. A method as claimed in claim 52, and further comprising receiving said computer code.
